(19) United States
(12) Patent Application Publication
(10) Pub. No.: US 2008/0206370 A1
(43) Pub. Date: Aug. 28, 2008

(54) Method For Treating Fungoid Growth of Rhizoctonia, Rythium and Phytophthora

(75) Inventors: Willem Govert Van Garderen, Almere (NL); Gerard Theodorus De Zeeuw, Austeritz (NL); Jan Copier, Ede (NL)

Correspondence Address: FOLEY AND LARDNER LLP;SUITE 500, 3000 K STREET NW, WASHINGTON, DC, 20007, US

(73) Assignee: COPIER ADVIESBUREAU B.V., AH Ede (NL)

(21) Appl. No.: 11/813,403

(22) PCT Filed: Jan. 5, 2006
(86) PCT No.: PCT/NL06/50004

§ 371 Date: Aug. 28, 2007

(30) Foreign Application Priority Data
Jan. 6, 2005 (NL) 1027964

(51) Int. Cl. A01N 65/00; A01P 3/00

(52) U.S. Cl. 424/744; 424/754

(57) ABSTRACT

The invention relates to a method for preventing or treating fungoid growth of the specie Rhizoctonia, Pythium and/or Phytophthora in a plant, in particular for treating chestnut disease, wherein the method comprises making a hole down to the root zone of the plant and putting into this hole a fungicidal composition that comprises an insect repellent age and a fungicide, where the insect repellent agent contains at least garlic and/or an extra thereof. The combination ensures that symbiotic fungoid growth and the biologic equilibrium of the soil are maintained and the vitality of the plant improves. As a result this, recovery is encouraged and recurrence of the disease syndrome after completion treatment is prevented to a large extent The method of administration according to the invention ensures homogeneous distribution by means of take up of the composition via the roots.

The present invention relates to a method for preventing or treating fungoid growth of the species Rhizoctonia, Pythium and/or Phytophthora, in particular of the species Pythium and/or Phytophthora, and simultaneously improving the vitality of a plant (vegetation), preferably of trees, shrubs, bushes and crops and in particular of trees and crops, by applying a fungicidal composition that comprises an insect repellent agent and a fungicide.

Fungoid growth of this land has caused large-scale damage to trees and crops in the past, a good example being the potato disease Phytophthora infestans in Ireland in the mid-nineteenth century.

More recently a new disease was discovered in the horse chestnut (Aesculus). This chestnut disease, also referred to as bleeding disease, can be recognised from miniscule rust-coloured spots on the trunk out of which brown liquid is running or has run. The disease makes no distinction between old or young, thick or thin chestnut trees. In a later stage of the bleeding disease, the bark bursts open and if the disease has encircled the the tree dies. This chestnut disease is attributed to a Phytophthora fungus, although this has not yet been unequivocally confirmed. Chestnut disease is often a combination of several factors, such as horse chestnut leaf miner, a shortage of oxygen in the soil, shortage of nutrients and other poor climatic conditions.

It is known in the state of the art that garlic (Allium sativum Linn.) and extracts thereof have an antibacterial and fungicidal action. EP-A 945 066 describes the effect of aqueous garlic extracts on the growth of fungi such as Candida albican, Aspergillus fumigatus and Aspergillus parasiticus and the use of garlic as a pesticide in plant diseases such as mildew.

There are also commercially available fungicides which can be employed against Rhizoctonia, Pythium and/or Phytophthora and other types of fungi, such as, for example, Aliette®D WG, based on fosetyl, Aaterra®, based on etridiazole, Previcur N®, based on propamocarb, Chipco Rovral® Green, based on iprodione (all commercially available from Bayer AG (Germany)) and Ridomil Gold EC, based on mefenoxam (Syngenta Crop Protection Inc., USA), but such fungicides are only capable of combating disease syndromes resulting from Rhizoctonia, Pythium and Phytophthora. At the same time such fungicides disturb the natural and biological equilibrium in the soil and symbiotic fungoid growth, which means that the plants have vitality problems after the treatment, have difficulty in recovering and the disease frequently recurs. Particularly in the case of chestnut disease, it often seems to take hold when the soil conditions are poor in any case, for example because of a low content of oxygen and/or nutrients. Moreover, these chemical fungicides are applied by spraying, which means numerous measures have to be taken to protect the natural environment from the toxic components in them.

One aim of the invention is therefore to improve the vitality of a plant, preferably a tree, shrub, bush or crop, and in particular of trees and crops, and at the same time to prevent and/or reduce fungoid growth of the abovementioned species. In particular an aim of the invention is to combat chestnut disease.

A further aim of the invention is to provide a method for administering such a fungicidal composition effectively, wherein the active constituents are dosed and administered evenly, without causing odour nuisance or other hail effects to the environment.

### DESCRIPTION OF THE INVENTION

The invention relates to a method for preventing or treating fungoid growth of the species Rhizoctonia; Pythium and/or Phytophthora in a plant, wherein the method comprises making a hole down to the root zone of the plant and putting into this hole a fungicidal composition that comprises an insect repellent agent and a fungicide, where the insect repellent agent contains at least garlic and/or an extract thereof.

According to the invention a plant is particularly understood to be the collection of trees, shrubs, bushes and crops. The method according to the invention is particularly suitable for preventing fungoid growth in trees and crops and more particularly a plant is understood to be a horse chestnut or Aesculus.

The method is particularly aimed at treating or preventing diseases associated with fungoid growth of the species Rhizoctonia, Pythium and/or Phytophthora. The method is also aimed at improving the vitality of the soil, maintaining the biological equilibrium in the soil and, in particular, the symbiotic fungoid growth, e.g. of miccorhiza, and the method is in particular aimed at treating and/or preventing chestnut disease or bleeding disease.

The insect repellent agent according to the invention is based on garlic, that is to say this agent contains at least garlic and/or an extract thereof. Garlic extract is defined in this case as any liquid that can be extracted from a garlic clove, including garlic oil and water. Garlic juice, such as prepared by pressing garlic cloves, is also suitable as a constituent in the insect repellent agent according to the invention. In the rest of this description these variants are referred to by the inclusive term “garlic”.

The fungicide that is used in the fungicidal composition according to the invention can be any fungicide that is used against Rhizoctonia, Pythium and Phytophthora fungi, but preferably the active constituent of the fungicide is fosetyl, etridiazole, propamocarb, iprodione or mefenoxam, or a combination thereof. Examples of such commercially available fungicides are Aliette® WG, Aaterra®, Previcur N®, Chipco Rovral® Green (Bayer AG (Germany)) and Ridomil Gold EC (Syngenta Crop Protection Inc., USA). It has been found that the combination of the insect repellent agent and one or more of the above-mentioned fungicides shows an unexpectedly enhanced fungicidal activity and improves the vitality of the soil and the plants rooted therein and that the combination is particularly suitable for treating and preventing chestnut disease by inhibiting the fungoid growth and simultaneously improving the vitality of the tree. Under (sic) this combination the chestnut disease is combated in such a way that after completion of treatment the disease syndrome does not occur in the chestnuts rooted in the treated soil for at least a month, more preferentially at least six months and most preferentially at least a year. Symbiotic soil life remains alive during treatment with the fungicidal composition according to the invention and antibodies are made in a natural way.

The choice of one or more fungicides in the fungicidal composition depends on the soil conditions for the plant, for example the content of sand, clay and peat in the soil. For a person skilled in the art it is easy to determine which fungicides work best for a particular type of soil.

Dosed administration of a fungicidal composition via the root canal leads to improved distribution of a (sic) the fungicidal composition over the entire plant, because after absorption via the roots the insect repellent agent is further transported through the plant in the xylem of the plant and is distributed over the entire plant, including root, trunk, branches and leaves. “Xylem” refers to the vascular combination that is responsible for the sport of water, minerals, nutrients and other, especially inorganic, substances through the plant. In the context of the invention the xylem consists of not only the wood vessels in the trunk or stem, but also all cells that contribute to the water transport through the plant, thus also the water channels such as those that start in the root hairs and end in the leaves and needles. By making the fungicidal composition available via the root hairs, much less material is lost than via spraying the outside of foliage of the plant.

As a result of this more efficient use a lower dosage of the active constituents of the fungicidal composition can suffice and this has the additional advantage that possible nuisance for the environment by the garlic, but more so by the disturbance of the biological equilibrium of the soil, is reduced. Moreover, a more long-lasting effect can also be achieved as a result of this more efficient use, which is of particular importance for the recovery period of the plants.

According to the invention at least one hole is made in the ground in which the plant is rooted and specifically within such a distance from the plant that this hole is situated in the “root zone”. The root zone is the ground layer in which the living roots are found, for practical reasons considered to be the layer in which the great majority of the roots are located. The root zone therefore comprises the entire surface of the surroundings of the plant where roots grow. In specific embodiments it is preferable that the holes are made in the “root hair zone”, that is to say the part of the root zone in which the root hairs occur. This root hair zone is located within the root zone on the outside. The take up of moisture and nourishment is highest in this location.

The average person skilled in the art will be able to estimate simply on the basis of the bulk of the plant visible above the ground how far and how deep the roots reach. In this respect it is preferable that at least one hole is made within the so-called crown projection, that is to say the margin of the crown, the bulk of the branches and the foliage, projected on the ground, preferably at least 1 metre within the margin of the crown projection. More preferentially at least one hole will be made at a distance of less than 1.5 metre, in particular within 1 metre of the outside of the trunk. The hole in the ground is preferably less than 1.5 metre, preferably between 20 cm and 1 metre deep in the ground.

Preferably several holes are made in the root zone, at least one per square metre of the crown projection, preferably in a uniform distribution around the trunk. The fungicidal composition can then be administered in a uniform manner. The necessary number of holes is furthermore dependent on the desired dosage of the composition and the disease syndrome of the plant and will be described in more detail below.

This hole is preferably a pop hole, that is to say a hole that is made with air pressure or, if so desired, finished off with air pressure after making the hole. This can be done, for example, by using a jet pipe, under high pressure. By “popping” the ground is aerated, airways are created, in particular in essentially the horizontal direction, in the root zone and disruptive layers are penned. In addition, oxygen is administered in this manner. This can be advantageous in cases where gas exchange in the ground is hindered by compaction of the ground as a result of, for example, vibrations due to traffic.

The insect repellent agent and the fungicide can be mixed together before they are put into the hole, but can also be put separately into the hole, the order in which they are put in not being important. The insect repellent agent and the fungicide in the fungicidal composition are preferably present in a mass ratio of 5:1 up to 1:2 inclusive, more preferentially in a ratio of 3:1 to 1:1.

In a preferred embodiment the fungicidal composition combined with a thickener is put into the hole. This is done, for example, by means of injection at high pressure. The thickener ensures that the composition has viscous properties and does not seep away into the ground rapidly. In this way retarded dosing of the composition over at least one and a half weeks is achieved.

The fungicidal composition is preferably put into the hole in a container and can in this case be applied before or after installing the container in the ground. However, it is preferable to place the container in the ground first and put the fungicidal composition into the container afterwards, wherein the insect repellent agent and the fungicide can be mixed in advance or put into the container separately one after the other. The hole has a diameter such that the container fits therein and is preferably—within the root zone—of such a depth that the container can be concealed under the surface around the plant.

The container can be closed, has preferably a removable cap and the container is provided with at least one perforation that makes controlled transport of the fungicidal composition to the outside possible and in this way ensures sustained administration of the fungicidal composition, preferably spread over 1 to 4 weeks, more preferentially at least one and a half weeks. The perforation is of such a size that the garlic (sic) is released only by the suction of the surrounding soil particles. Consequently, it is preferable that the perforation has a size of 0.5-1 mm.

Preferably several, more preferentially between 3 and 10 perforations are made so as to reduce the risk of blockage. These several perforations can be situated on one or several sides of the container, but at least one perforation will be located in the bottom so as to prevent material being left on the base of the container. The perforations are preferably uniformly distributed over the height of the container. By using closed containers provided with one or more small perforations retarded dosage of the fungicidal composition is achieved and flushing out downwards, away from the root zone, is prevented prevented (sic). If necessary the speed of release can be increased by making additional perforations in a container that already has one or more perforations. The speed of release could also be reduced by sealing off, for example with tape, one or more perforations.

The container is preferably made of a plastic. The container can be in the form of a tube, in particular a tube with a length between 20 and 80 cm and a diameter between 5 and 100 mm. The container has preferably a capacity of 4 ml-6.3 l, more preferentially 0.25-3.0 litre.

In another preferred embodiment the container is a drainage hose. This drainage hose is placed in the hole such that this is located essentially horizontally in the root zone. The hole is then a trench, preferably a ring-shaped trench around the trunk, preferably with a depth of 20 cm-1 m within the root hair zone. The drainage hose can be closed at both ends with a removable cap, but at at least one end, so that there is a filling point. The other end can then be closed permanently. Such a drainage hose has the advantage that this can easily be spread over a large area, for example as an unbroken piece around a plant, or stretched out along a row of plants. Thus a large area can be covered using a drainage hose and there is an added advantage that the entire area can be provided with the composition via one filling point. This can in particular be advantageous if administration has to be carried out several times, so the drainage hose can be reused. In such an embodiment the drainage hose has more perforations, depending on the length of the hose and the area that this covers. Consequently, in the description and appended claims, the term “container” also includes a drainage hose.

After putting the insect repellent agent into the hole in the root zone the hole is closed. In this case it is preferable to cover the hole again with the original material, such as topsoil or paving.

The position of the container can be marked in order to find the location thereof easily, for example in order to be able to remove the container later. However, the container can in this way also be reused in order thus to save the costs of the container and the work associated with installation thereof.

The fungicidal composition is preferably mixed with water before it is put into the hole, such that the insect repellent agent is present in the hole in a mass ratio with respect to water that lies between 1:5 and 1:200, preferably between 1:40 and 1:110. The mass ratio of the fungicide with respect to water in the hole can be determined on the basis of this and the abovementioned limit on the ratio insect repellent agent:fungicide. If the fungicide and the insect repellent agent are put into the hole separately, they are preferably first mixed with water in such a way that they are ultimately in the abovementioned ratios in the fungicidal composition in the hole. If a container is used, the fungicidal composition may be mixed with water immediately before the container is placed in the hole, but also after the container is already in the hole.

Furthermore, it is possible that a binder is added to the mixture of water and fungicidal composition. If the fungicidal composition is put into the hole directly—without container—a binder has to be added. This binder imparts a viscous character to the aqueous fungicidal composition and by this means retards the dosing of the fungicide and the insect repellent agent to the surroundings. By this means it is possible to keep the fungicidal composition active in the ground for a longer time. The binder is preferably a biological thickener, more preferentially on the basis of starch. The binder is preferably mixed with water in combination with the insect repellent agent. The mass ratio of the solid constituents of the the (sic) insect repellent agent and the binder in the fungicidal composition lies between 3:1 and 1:3. The binder is preferably present in the final fungicidal composition in a mass ratio with respect to water that preferably lies between 1:1.5 and 1:600, in particular between 1.13 and 1:330.

It has been found that the garlic has to be administered in an amount, in the case of a tree, between 40 and 160 milligram per centimetre trunk thickness, preferably 60-140 mg per centimetre trunk thickness, and in the case of a bush, between 4 and 20 mg per centimetre bush breadth, preferably 10-18 mg per centimetre bush breadth.

After administration the active substances according to the invention are released into the ground, they are taken up via the root and transported to the other parts of the plant.

The invention further relates to a combination of a container that can be closed and has at least one perforation, an insect repellent agent that contains at least garlic and/or an extract thereof and a fungicide. This fungicidal combination is suitable for administration according to the invention.

Furthermore, the container can have the characteristics as described above.

The fungicide is one or more of the group as described above.

Furthermore, it is preferable that the insect repellent agent contains one or more of seaweed extract, soya oil and aloe vera.

Seaweed extract enhances the activity of the garlic and, moreover, also has a fungicidal action, although in itself it is insufficient to combat the abovementioned fungi. Preferably, on a dry weight basis, the insect repellent agent contains 10-60% (m/m), preferably 20-55% (m/m) garlic and/or an extract thereof and 2-20% (m/m) seaweed extract.

Soya oil has a transport function and in this way ensures improved take up of the composition by the plant. The amount thereof is preferably 1-30% (m/m), preferably 2-20% (m/m), on dry weight basis.

Aloe vera contributes to the vitality of the soil and the plant and is preferably present in an amount of 1-10% (m/m), on dry weight basis. This limits or even prevents disturbance of the biological equilibrium of the soil by the fungicides.

The insect repellent agent according to the invention can additionally contain one or more of nut leaf extract, parsley extract, African Marigold extract, Nepeta extract and Urtica extract. Most preferentially all the listed constituents are present in the compound together. Preferably the insect repellent agent according to the invention contains these constituents, if present, in an amount of:

1-10% (m/m) nut leaf extract;

1-20% (m/m) parsley extract;

1-10% (m/m) African Marigold extract;

1-10% (m/m) Nepeta extract; and

2-20% (m/m) Urtica extract, on dry weight basis.

A binder can be added to increase viscosity and consequently to retard the dosing. This binder is preferably on the basis of starch. The ratio of the binder with respect to the rest of the solid constituents in the insect repellent agent lies between 3:1 and 1:3. Besides an insect repellent effect he insect repellent agent also has a fungicidal and/or antifungal action and it also ensures better vitality of the plant.

The insect repellent agent according to the invention can be in the form of a tablet or capsule, but can also be available in the form of an aqueous solution, where the total amount of solid constituents is between 10-100 gram per litre water. If the composition is in the form of a capsule or tablet it is preferable that the ratio of the solid constituents of the agent and water in the mixture is between 1:5 and 1:50, preferably 1:5-1:20. For administration according to the invention the insect repellent agent is diluted with water to a dosage that is effective according to the aim of the invention and as described above.

The fungicidal composition according to the invention is particularly suitable for treating and/or preventing fungoid growth of the species Rhizoctonia, Pythium and/or Phytophthora, in particular of the species Pythium and/or Phytophthora, in trees, plants, shrubs, bushes or crops, preferably for treating and/or preventing chestnut disease. The fungicidal composition can also be used preventatively, to prevent fungoid growth and associated diseases and/or to improve the vitality of the plant.

### EXAMPLES

### Example 1

A fungicidal composition was prepared by putting 40 gram of an insect repellent agent and 20 gram of a fungicide Aliette® WG, obtained from Bayer AG (Germany), into a tube with a capacity of approx. 2 litre and 4 evenly distributed perforations on the long side and 1 perforation in the bottom and making it up to 2 kilogram with water. The insect repellent agent was based on water and contained per litre of water:

9 g garlic;

2 g soya oil;

1 g parsley extract;

2 g seaweed extract;

1 g nut leaf extract;

1 g aloe vera;

1 g African Marigold extract;

1 g Nepeta extract;

2 g Urtica extract,

with a total of 20 gram of constituents and wherein the constituents were extracted in 100 ml ethanol by means of preheating before being put into the water and then mixed with hand-hot tap water.

### Example 2

Chestnut disease was ascertained in a chestnut tree with a crown projection of 10 m². To treat this tree, 10 holes were made in the ground in the crown projection. These holes were dug to a depth of 60 cm and were located in a circle evenly distributed around the trunk, each at a distance of about 1 m from the tree. A container with a fungicidal composition prepared according to Example 1 was placed in each hole. The tubes were closed with a lid. The ground was covered over with the original soil. After two weeks following covering spot checks were made by digging up one or more tubes and confirming whether fluid had disappeared. During the treatment callogenesis occurred at the edges of the disease wounds, as a result of which the wounds healed. Moreover, during the growing season the tree became more vital, which was evident from green leaves and less leaf miner.

1-17. (canceled)

18. A method for preventing or treating fungoid growth of the species Rhizoctonia, Pythium and/or Phytophthora in a plant, the method comprising:
(a) making a hole down to the root zone of the plant, and
(b) administering via the hole a fungicidal composition comprising an insect repellent agent and a fungicide, wherein the insect repellent agent comprises at least garlic, an extract thereof, or both.

19. The method according to claim 18 wherein the plant has chestnut disease.

20. The method according to claim 18, wherein the insect repellent agent further comprises seaweed extract, soya oil, aloe vera, or a combination thereof.

21. The method according to claim 18, wherein the fungicide comprises fosetyl, etridiazole, propamocarb, iprodione or mefenoxam or a combination thereof.

22. The method according to claim 18, wherein the insect repellent agent and the fungicide are present in the fungicidal composition in a mass ratio of 5:1 up to 1:2, inclusive.

23. The method according to claim 18, wherein the fungicidal composition is administered via the whole in a container, wherein the container is provided with at least one perforation.

24. The method according to claim 23, wherein the container is a drainage hose.

25. The method according to claim 18, wherein the fungicidal composition further comprises a binder.

26. A fungicidal product for preventing or treating fungoid growth of the species Rhizoctonia, Pythium and/or Phytophthora, the product comprising an insect repellent and a fungicide, wherein the insect repellent agent comprises at least garlic, an extract thereof, or both.

27. The fungicidal product according to claim 26, wherein the insect repellent further comprises seaweed extract, soya oil, aloe vera, or a combination thereof.

28. The fungicidal product according to claim 26, wherein the insect repellent is in the form of a tablet or capsule.

29. The fungicidal product according to claim 26, wherein the insect repellent is in the form of an aqueous solution comprising 10-100 grams of constituents per litre water.

30. The fungicidal product according to claim 26 packaged in a container.

31. The fungicidal product according to claim 30, wherein the container has between 3 and 10 perforations.

32. The fungicidal product according to claim 26, wherein the fungicide comprises fosetyl, etridiazole, propamocarb, iprodione or mefenoxam or a combination thereof.

33. A method of treating or preventing chestnut disease comprising administering a fungicidal composition comprising an insect repellent and a fungicide, wherein the insect repellent agent comprises at least garlic, an extract thereof, or both.

34. The method according to claim 33, wherein the insect repellent agent further comprises seaweed extract, soya oil, aloe vera, or a combination thereof.

35. The method according to claim 34, wherein the fungicide comprises fosetyl, etridiazole, propamocarb, iprodione or mefenoxam or a combination thereof.
